(19) United States
(12) Patent Application Publication
(10) Pub. No.: US 2026/0225607 A1
(43) Pub. Date: Aug. 6, 2026

(54) NAVIGATING PROXIMATE STATIONARY ROADWAY OBJECTS

(71) Applicant: Zoox, Inc., Foster City, CA (US)

(72) Inventors: Abishek Krishna Akella, San Francisco, CA (US); Lian Cui, Foster City, CA (US)

(21) Appl. No.: 19/042,630

(22) Filed: Jan. 31, 2025

(51) Int. Cl. B60W 60/00; B60W 50/00

(52) U.S. Cl. CPC B60W 60/001; B60W 50/0097; B60W 2520/10; B60W 2552/53; B60W 2554/20; B60W 2555/60

(57) ABSTRACT

Techniques for navigating proximate a double-parked vehicle (“DPV”) are described herein. A vehicle may receive sensor data of the environment. The vehicle may analyze the sensor data to determine that a DPV is located within a laterally adjacent, oncoming traffic driving lane. The vehicle may generate a heatmap based on the attributes of the DPV and use the heatmap to determine the cost of following one or more candidate actions. For example, the vehicle may generate candidate action(s) for the vehicle to follow. The cost may be determined, for a state of the vehicle along a candidate action, based on the amount (or fraction) of the vehicle within the heatmap and the weight of the heatmap. Upon determining the cost(s) for the candidate actions, the vehicle may use such data to determine a control trajectory for the vehicle to follow.

### BACKGROUND

Vehicles, such as autonomous vehicles, may navigate along designated routes. In some examples, the vehicle may navigate proximate dynamic and/or static objects. The vehicle may generate vehicle actions based on predicting future actions of the object(s). However, in some circumstances, techniques for generating vehicle actions based on the predicted future actions of the object(s) may result in inaccurate and/or suboptimal results.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial flow diagram illustrating an example technique for navigating proximate oncoming object(s) and/or double-parked vehicle(s), in accordance with one or more examples of the disclosure.

FIG. 2 depicts an example computing system including a planning component configured to increase the ability of a vehicle to generate optimal actions proximate a DPV, in accordance with one or more examples of the disclosure.

FIGS. 3A and 3B illustrate an example environment including a weighted heatmap surrounding a double-parked vehicle, in accordance with one or more examples of the disclosure.

FIG. 4 illustrates an example environment include multiple weighted heatmaps that are merged into a single heatmap, in accordance with one or more examples of the disclosure.

FIG. 5 depicts a block diagram of an example system for implementing various techniques described herein.

FIG. 6 is a flow diagram illustrating an example process for detecting a double-parked vehicle, determining a heatmap surrounding the double-parked vehicle, generating cost(s) for a candidate action based on the heatmap, determining to follow the candidate action based on the cost, and controlling the vehicle based on the candidate action, in accordance with one or more examples of the disclosure.

### DETAILED DESCRIPTION

Techniques for navigating proximate a double-parked vehicle are described herein. As described herein, weighted heatmap(s) may be used to determine costs associated with following a candidate action proximate a double-parked vehicle (“DPV”). In some examples, a vehicle (such as an autonomous vehicle) may receive sensor data of the environment. The vehicle may analyze the sensor data to determine that a DPV is located within a laterally adjacent, oncoming traffic, driving lane. In some examples, the vehicle may generate a heatmap based on the attributes of the DPV and use the heatmap to determine the cost of following one or more candidate actions. For example, the vehicle may generate one or more candidate actions for the vehicle to follow. The cost may be determined, for a state of the vehicle along a candidate action, based on the amount (or fraction) of the vehicle within the heatmap and the weight of the heatmap. Upon determining the cost(s) for the candidate actions, the vehicle may use such data to determine a control trajectory for the vehicle to follow. As discussed throughout this disclosure, the techniques described herein may improve vehicle safety and/or driving efficiency by increasing the ability of the vehicle to determine cost values that accurately represent the cost of following a trajectory, thereby allowing the vehicle to perform safer and more efficient driving maneuvers.

When determining whether to wait or go around a DPV, it may be beneficial to consider potential actions of objects located in the same lane as the DPV. Such potential object actions may be based on responding to the presence of the DPV. For example, a vehicle may navigate an environment with static and/or dynamic objects. While navigating to a destination, the vehicle may encounter a stationary object that is blocking at least a portion of a laterally adjacent driving lane. In such instances, the stationary object may be a DPV. Further, in an environment where vehicles drive on the right side of the road, the lane to the left of the vehicle, which is the lane within which the DPV is located, may be an oncoming traffic lane. In such examples, as the vehicle approaches the DPV, the vehicle may determine whether to wait for other objects in the oncoming traffic lane to go around the DPV or whether to continue past the DPV. However, in some cases, performing such actions may result in the vehicle detecting an oncoming object behind the DPV and stopping in the driving lane which may block the passage of object(s) in either direction of travel, or continue driving as if the DPV did not exist which may increase an unintended or undesired direct or indirect result in which the vehicle or object(s) interact with the DPV or one another. As such, the techniques and/or systems described herein may increase the quality and/or accuracy of the costs used to evaluate candidate actions such that the vehicle does not block traffic.

To address these and other technical problems and inefficiencies, the systems and/or techniques described herein include a planning component (which also may be referred to as a “planner component” or a “planning system”) configured to enable vehicles to navigate proximate a DPV. Further, the planning component may leverage one or more weighted heatmaps surrounding the DPV to determine one or more cost values. Technical solutions discussed herein solve one or more technical problems associated with spending excessive amounts of time unnecessarily waiting behind DPVs and/or blocking traffic. Of course, in other examples, the techniques and/or systems described herein may not be limited to a planning component; in other examples, such systems may be associated with any other component or module within the vehicle.

In some examples, the vehicle may receive sensor data representative of an environment. That is, the vehicle may capture sensor data while navigating an environment. The vehicle may include one or more sensor device(s) (e.g., lidar device(s), radar device(s), time-of-flight device(s), image capturing device(s), etc.) located or mounted at various positions within or on the vehicle body. In such cases, the sensor device(s) may capture sensor data of the environment proximate the vehicle.

In some examples, the vehicle may detect one or more stationary object(s) based on the sensor data. That is, the vehicle may analyze the sensor data and identify one or more object(s) within the environment. For example, the sensor data may include one or more static and/or dynamic objects such as other vehicle(s) (e.g., cars, trucks, motorcycles, cyclists, etc.), pedestrians, animals, stationary object(s) (e.g., dynamic objects that have a velocity of zero), trees, bushes, buildings, signage, road markings, etc. The vehicle may detect the object(s) using one or more machine-learned models. In some examples, the object(s) may include various types of object data (or object features) such as a classification (or type), a pose (e.g., position (e.g., x- and y-coordinate) and/or heading (or yaw)), a size, a velocity, an acceleration, a track (or history), etc. Further, the vehicle may determine that the object is a stationary object based at least in part on determining a stationary intent (e.g., the object is predicted to remain stationary) and/or a velocity below a threshold level. Example techniques for detecting or otherwise determining stationary objects can be found, for example, in U.S. Pat. No. 11,188,082, filed Jan. 11, 2019, and titled “Occlusion Prediction and Trajectory Evaluation,” as well as in U.S. Pat. No. 10,955,851, filed Feb. 14, 2018, and titled “Detecting Blocking Objects” the contents of which is herein incorporated by reference in its entirety and for all purposes.

In some examples, the vehicle may determine that the stationary object is a DPV. A DPV may be a blocking vehicle (or object), a blocking pedestrian, a parked or disabled (e.g., velocity below a threshold value) vehicle laterally adjacent to an already parked vehicle along the side of a road, and/or a parked or disabled vehicle proximate the side of a road without a laterally adjacent parked vehicle (e.g., delivery truck stopping in the road despite no laterally packed vehicle). In some examples, the vehicle may determine that a stationary object is a DPV based on a distance from a side of the stationary object to a lane marker being below a threshold amount (e.g., using map data (e.g., road network data)). The threshold amount may be determined based on a classification and/or type of an object approaching the DPV in the same driving lane as the DPV. That is, the threshold may be based on a width of the approaching object that is longitudinally behind the DPV. If the distance is below the threshold, the vehicle may determine that the DPV is sufficiently within the driving lane and that the approaching object is unable to travel past the DPV without exiting the current driving lane. In contrast, if the distance meets or exceeds the threshold, the vehicle may classify the object as a non-DPV and may not use the heatmaps described below when determining costs associated with navigating proximate the non-DPV.

Based on determining that the stationary object is a DPV, the vehicle may determine a heatmap around the DPV. A heatmap may correspond to a physical region of the environment and may include a weighted value. In some examples, different regions of the heatmap will have different weighted values (e.g., portions of the heatmap closer to the DPV may have higher weights than portions further from the DPV). In some examples, all values within the heatmap will be weighted the same or similarly and all values outside of the heatmap may not have a value associated with the heatmap. In some cases, one or more vehicle components may determine the weighted heatmap(s) during a pre-computation stage and/or by a remote server-based system. For example, a pre-computation stage may be a moment in which the vehicle turns on, initializes, and/or any other situation. As such, the planning component may receive, request, and/or determine the previously generated heatmap(s) when approaching a DPV. Generating the weighted heatmaps during a pre-computation stage may improve computational efficiency by reducing the amount of processing for the vehicle to perform in real-time scenarios.

In some examples, the vehicle component(s) may determine the heatmap dimensions based on attributes of the DPV and/or any approaching object(s) in the same driving lane as the DPV. For example, the vehicle component(s) may generate the heatmap such that the heatmap is centered around the DPV. The length of the heatmap may be the length of the DPV plus a buffer and the width of the heatmap may be the width of the DPV plus a buffer. Additionally or alternatively, the length and/or width of the heatmap may also be based on an orientation of the DPV within the driving lane, a velocity of the vehicle (e.g., increase the length of the heatmap to account for the increased velocity), a velocity of object(s) around the DPV or vehicle, for example an oncoming vehicle that is driving in the lane at least partially occupied by the DPV, driving opposite to that of the direction of travel of the vehicle, and likely to make a maneuver or follow a trajectory that interacts with the DPV had the DPV not been present, semantic information regarding the environment (such as lane width, traffic signs, etc.), a predicted acceleration and/or predicted acceleration capability of the DPV, etc. In such cases, the vehicle may generate a single heatmap for a DPV. Additionally or alternatively, in situations in which there are multiple DPVs, the vehicle may merge the multiple heatmaps of the multiple DPVs into a single heatmap. In some examples, the heatmap may be determined with respect to a global or local coordinate system and as such, the various regions (and/or edges) of the heatmap may correspond to geographical coordinates.

In some examples, the vehicle may generate one or more candidate actions. A candidate action may be a trajectory that includes a spatial representation of future movements of the vehicle in addition to one or more vehicle controls (or control data) (e.g., velocity, acceleration, yaw, steering angle, etc.). That is, the candidate actions may include instructions that instruct the vehicle how to navigate a portion of the environment. The candidate actions can include instructions that cause the vehicle to perform one or more actions, such as remain in the same lane, lane change left, lane change right, pass an object proximate the vehicle, modify vehicle kinematics (e.g., velocity, acceleration, etc.), and/or any other type of action. In some examples, a candidate action may include multiple predicted states that can represent the state information of the vehicle at a specific location along the candidate action. State information may include location data, pose data (e.g., lateral offset data, longitudinal offset data, heading offset data), velocity data, acceleration data, and/or other types of data. Examples of various techniques for generating planner actions (or trajectories) for autonomous vehicles can be found, for example, in U.S. Pat. No. 10,921,811, filed on Jan. 22, 2018, issued on Feb. 16, 2021, and titled, “Adaptive Autonomous Vehicle Planner Logic,” in U.S. patent application Ser. No. 18/540,642, filed Dec. 14, 2023, and titled “Machine-Learned Cost Estimation in Tree Search Trajectory Generation for Vehicle Control,” in U.S. Pat. No. 11,875,678, filed on Jan. 21, 2021 and issued on Jan. 16, 2024, and titled “Unstructured Vehicle Path Planner,” and in U.S. Pat. No. 10,955,851, filed on Feb. 14, 2018, issued on Mar. 23, 2021, and titled, “Detecting Blocking Objects,” each of which is incorporated by reference herein in its entirety and for all purposes.

In some examples, the planning component may generate a control trajectory which may be a combination of the one or more candidate actions. For instance, to determine which of the one or more candidate actions to follow, the planning component may use a tree structure. Accordingly, the planning component may generate a tree structure that includes some or all of the candidate actions. A tree structure may include one or more nodes representing vehicle states at different action layers of the tree structure. Further, each vehicle state may include multiple candidate actions which the vehicle may follow. As described in more detail below, the planning component may use the tree structure to determine or otherwise select one or more of the candidate actions to follow from a node in the tree structure to a different node at the next layer of the tree structure. The planning component may determine which candidate actions to follow between layers of nodes based on one or more costs. Example techniques for generating a tree structure and determining a control trajectory based on the tree structure can be found, for example, in U.S. application Ser. No. 17/900,658, filed Aug. 21, 2022, and titled “Trajectory Prediction Based on a Decision Tree,” the content of which is herein incorporated by reference in its entirety and for all purposes.

In some examples, the planning component can determine a control trajectory based on the tree structure. The planning component can evaluate some or all candidate actions when determining a control trajectory. A solution to the tree may result in a series of nodes of the one or more candidate actions which, when traversed (e.g., moving along and between differing trajectories and/or action layers of the tree structure), results in a control trajectory (e.g., output trajectory) having a lowest determined overall cost. An overall cost for the control trajectory may represent and/or be indicative of the combination of one or more sub-costs. A cost value can indicate the safety, progress, comfort, risk, convenience, and/or efficiency of a candidate trajectory. For instance, a high cost value may indicate heightened degree of risk, danger, inconvenience, discomfort, and/or inefficiency of the trajectory. In contrast, a low cost value may indicate a lower degree of risk, danger, inconvenience, and/or inefficiency of the trajectory. In some examples, sub-costs may include comfort-related costs (e.g., acceleration cost, jerk cost, steering cost, path reference cost, etc.), legality-related costs, policy-related costs, safety-related costs (e.g., lane changing costs), progress costs, debris cost, a lane blocking cost, a lane ending cost, an exit cost, an approach cost, a space cost, a payment cost, a yaw cost, adversarial cost(s), lane targeting cost (e.g., cost associated with the vehicle being located in a desired lane), cyclist-related cost(s), DPV passing cost, and/or any other type of cost.

In some examples, when determining a DPV passing cost or lane blocking cost, the vehicle may determine such costs using the heatmap. That is, the vehicle may use the heatmap to determine a sub-cost for some or all of the candidate actions. When determining the sub-cost, the vehicle may perform one or more of Equation 1 or Equation 2 below:

$$Cost = ω * b \qquad Equation 1$$

In this equation, the Cost may be the DPV passing cost or the lane blocking cost which may be sub-cost(s). The ω may be the weight value that may be encoded in (or otherwise associated with) the heatmap. The b may be the fraction, percent, or amount of the vehicle body that is physically within the heatmap at the vehicle state being evaluated. For example, if half of the vehicle body is within the heatmap, the b may be 0.5. The vehicle may determine the b based on determining the coordinates of the vehicle body at the vehicle state and comparing such coordinates to the coordinates of the heatmap. Performing the operations in Equation 1 may result in a sub-cost value that may be used to determine the overall cost of following an action. In addition to Equation 1, the vehicle may perform the following equation:

$$Cost = ω * b * \frac{{v}_{limit}}{max ( {v}_{v e h i cle} , {v}_{0} )} \qquad Equation 2$$

In this equation, the Cost may be the DPV passing cost or the lane blocking cost. The ω may be the weight value that may be encoded in the heatmap. The b may be the fraction, percent, or amount of the vehicle body that is physically within the heatmap at the vehicle state being evaluated. The vₗᵢₘᵢₜ may represent the speed limit associated with the roadway and the max(v_{vehicle}, v₀) may represent the velocity of the vehicle. In this equation, the planning component may consider the vehicle velocity to discourage low velocities through the heatmap region and to encourage the vehicle to either wait prior to entering the heatmap region or to proceed through the heatmap region without stopping. Though not included in Equation 1 or 2, the vehicle may also consider the current and/or predicted attributes (e.g., acceleration, velocity, steering angle, pose, etc.) of the approaching object(s) when determining the Cost. That is, the vehicle may perform the operations of Equation 2 with respect to an oncoming object (e.g., velocity of object, velocity or speed limit of the driving lane within which the object is located, etc.).

Upon determining the sub-cost(s), the planning component may determine or otherwise combine the sub-costs into a single overall cost. In some examples, the vehicle may determine to follow a control trajectory that has the lowest overall cost compared to the overall costs of other potential traversal paths between the candidate trajectories. Of course, in other examples, the planning component may use one or more machine-learned models to determine the control trajectory.

In some examples, the vehicle may follow the control trajectory while operating within the environment. Upon determining the control trajectory from the tree search, the vehicle may follow the control trajectory throughout the environment. As such, the vehicle may be controlled based on the sub-cost(s).

The techniques described herein can improve the functioning, safety, and efficiency of autonomous and/or semi-autonomous vehicles operating in various driving environments. Determining the heatmaps during the pre-computation stage as described herein may improve computational efficiency by reducing the amount of processing for the vehicle to perform in order to determine reduced cost values. The improved computation efficiency can increase computing speeds which may enable the vehicle to determine cost values sooner, thereby enabling the vehicle to determine vehicle trajectories sooner. Further, the heatmap(s) may increase the ability of the vehicle to not block the driving lanes.

The techniques described herein may be implemented in several ways. Example implementations are provided below with reference to the following figures. Although discussed in the context of an autonomous vehicle, the methods, apparatuses, and systems described herein may be applied to a variety of systems, and are not limited to autonomous vehicles. In another example, the techniques may be utilized in an aviation or nautical context, or in any other system. Additionally, the techniques described herein may be used with real data (e.g., captured using sensor(s)), simulated data (e.g., generated by a simulator), or any combination of the two.

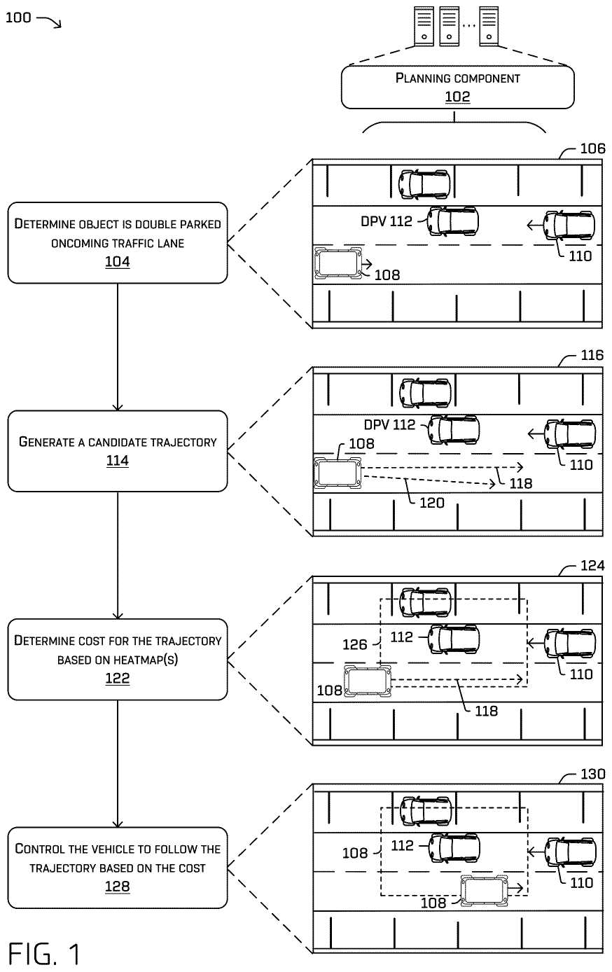

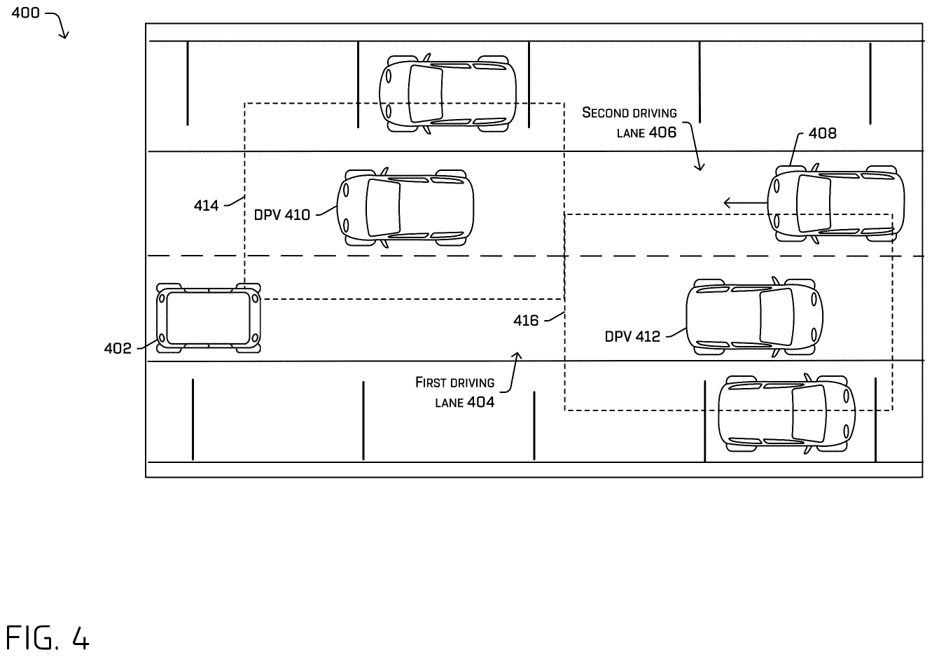

FIG. 1 is a pictorial flow diagram illustrating an example technique for navigating proximate oncoming object(s) and/or double-parked vehicle(s). As shown in this example, some or all of the operations in the example process 100 may be performed by a planning component 102 and/or other components and systems within an autonomous vehicle. Though the techniques described in FIG. 1 and throughout are with respect to a DPV in an oncoming driving lane, this is not intended to be limiting. As shown in FIG. 4, the techniques described herein can be used when the DPV is on either side of a road and/or in either direction of traffic compared to the vehicle.

At operation 104, the planning component may determine that an object is a DPV parked in an oncoming traffic lane. A vehicle may navigate in an environment that includes dynamic and/or static objects. In some examples, a static object may be a DPV when the static object is parked at least partially within the driving lane of the vehicle or one of the laterally adjacent driving lanes. For example, box 106 illustrates a DPV parked at least partially within a laterally adjacent driving lane. In this example, the box 106 may include a vehicle 108 navigating in a first driving lane in a first direction. Further, the box 106 includes an object 110 navigating in a second driving lane that is laterally adjacent to the first driving lane within which the vehicle 108 is located. The second driving lane may correspond to a second and different direction of travel from the first direction of travel of the vehicle 108. In some examples, the object 110 may be a vehicle; however, in other examples, the object 110 may be any other type of dynamic object (e.g., cyclist, pedestrian, etc.).

In some examples, the box 106 may include a DPV 112 that is located at least partially within the second driving lane. As shown, the DPV 112 may be a vehicle; however, in other examples, the DPV 112 may be any other type of obstructing static object (e.g., cones, signage, etc.). In some examples, the planning component 102 may determine that the DPV 112 is a DPV based on the distance from a side of the DPV 112 to a lane marker being below a threshold distance. The threshold may be based on a classification and/or type of the object 110 (e.g., an approaching object). That is, if the distance between the side of the DPV 112 and the lane marker that divides the first and second driving lanes is less than a threshold, the planning component 102 may determine that there is insufficient space for the object 110 to pass the DPV 112 and as such, the DPV 112 is a DPV.

At operation 114, the planning component 102 may generate candidate actions for the vehicle to follow. That is, the vehicle 108 may generate and/or evaluate one or more candidate actions and determine which of the candidate actions to follow. For example, box 116 illustrates multiple candidate actions for the vehicle 108 to follow. In this example, box 116 may include a candidate trajectory 118 that instructs the vehicle 108 to navigate along a left side portion of the first driving lane and a candidate trajectory 120 which instructs the vehicle 108 to navigate along a right side portion of the first driving lane.

At operation 122, the planning component 102 may determine cost(s) of following the candidate trajectories based on a heatmap. In some examples, based on identifying the DPV 112, the planning component 102 may generate a heatmap that corresponds to a region of the environment around the DPV 112. When generating the heatmap, the planning component may encode a weight value (e.g., 0, 1, etc.) therein. For example, the box 124 illustrates a heatmap 126 surrounding (or encompassing) the DPV 112. In this example, the heatmap 126 may be centered on the DPV 112; however, in other examples, the heatmap 126 may be off-center from the DPV 112. As shown, the heatmap 126 may include a length and width that is proportional to the length and width of the DPV plus buffer lengths.

As noted above, the planning component 102 may determine one or more cost values associated with following the candidate trajectories. In some cases, one of the cost values may be a lane bocking cost and/or a DPV-related cost. When determining such cost(s), the planning component 102 may use the heatmap 126. For example, the planning component 102 may determine the cost(s) by performing the techniques in Equations 1 and/or 2. That is, the cost may be a combination of the amount of the vehicle 108 within (or otherwise occupying a region of) the heatmap 126 multiplied by the weight of the heatmap 126. For example, in this situation, approximately 25% of the vehicle 108 body overlaps with the heatmap 126. As such, 0.25 may be the overlap value (e.g., b) that is multiplied with the weighted value of the heatmap 126. In some cases, the planning component 102 may use the cost that is determined from Equations 1 and/or 2 to determine an overall cost for following the candidate actions.

At operation 128, the planning component 102 may control the vehicle to follow the candidate trajectory 118 based on the cost determined at operation 122. That is, the planning component 102 may use the overall cost value determined at operation 122 to determine a control trajectory for the vehicle 108 to follow. In some cases, the control trajectory may be either the candidate trajectory 118, the candidate trajectory 120, and/or a combination thereof. As shown in this example, box 130 illustrates the vehicle 108 following the candidate trajectory 118. That is, the vehicle 108 may follow the candidate trajectory 118 such that the vehicle 108 passes through the blocking region, thereby reducing a likelihood of blocking the roadway.

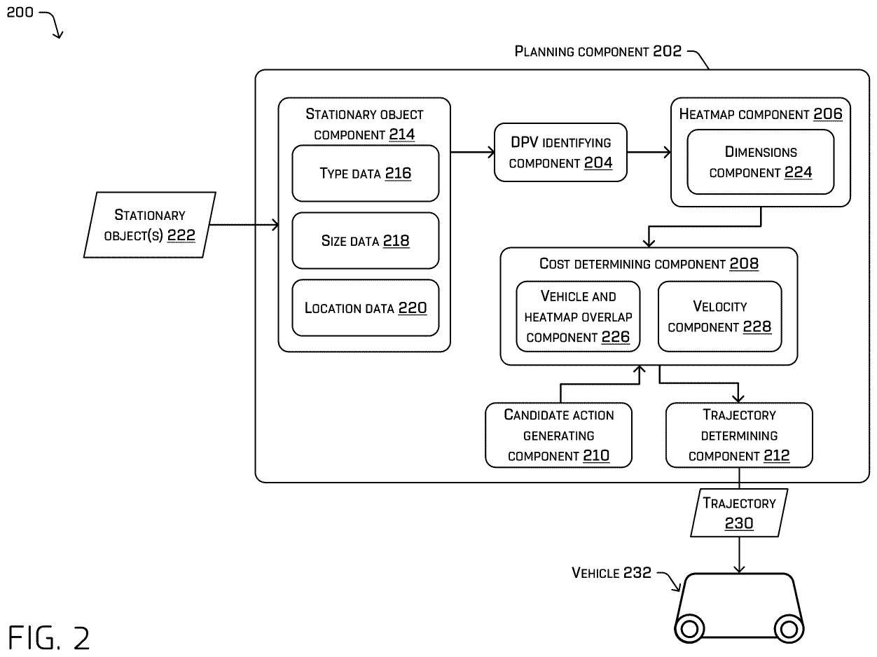

FIG. 2 depicts an example computing system 200 including a planning component 202 configured to increase the ability of a vehicle to generate optimal actions proximate a DPV.

In some examples, the planning component 202 may be similar or identical to the planning component 102 described above, or in any other examples herein. As noted above, in some cases the planning component 202 may be a component of an autonomous vehicle. In some examples, the planning component 202 may include various components, described below, configured to perform different functionalities of a trajectory determining technique. In some examples, some or all of the subcomponents of the planning component 202 may be integrated in a remote server-based system while other subcomponents may be integrated in on-vehicle systems. In some examples, the planning component 202 may include a DPV identifying component 204 configured to identify DPV(s) from a list of stationary object(s), a heatmap component 206 configured to determine one or more weighted heatmaps, a candidate action generating component 210 configured to generate candidate actions for the vehicle to follow, a cost determining component 208 configured to determine the cost of candidate trajectories, and/or a trajectory determining component 212 configured to select or otherwise determine a candidate trajectory to follow.

In some examples, the planning component 202 may receive stationary object(s) 222 from one or more components of the autonomous vehicle. In some examples, the stationary object(s) 222 may be identified by one or more of a perception system, a prediction system, or a planning system. The stationary object(s) 222 may be an object that has a velocity below a threshold value (which may be for a threshold period of time), an object that has a stationary intent as described above, and/or is otherwise detected to be a blocking object. As shown in this example, the stationary object component 214 may receive the stationary object(s) 222. The stationary object component 214 may be configured to receive, store, synchronize, and/or analyze the stationary object(s) 222 received from one or more components of the vehicle.

In this example, the stationary object component 214 may include one or more components associated with different features of the stationary object(s) 222. As illustrated in FIG. 2, the stationary object component 214 may include features of the stationary object such as type data component 216, size data component 218, and/or location data component 220. Of course, in other examples the stationary object(s) 222 may include more or less features. In this example, the type data component 216 may be used to determine, store, and/or synchronize a type and/or characterization of the stationary object(s) 222. The size data component 218 may be used to receive, store, and/or synchronize the size and/or dimensions of the stationary object(s) 222. The location data component 220 may be used to receive, store, and/or synchronize the location and/or pose of the stationary object(s) 222. In some examples, the stationary object component 214 may send stationary object(s) 222 data to the DPV identifying component 204 for further analysis.

In some examples, the planning component 202 may include a DPV identifying component 204 configured to identify DPV(s) from a list of stationary object(s). In some instances, the DPV identifying component 204 may utilize the data in the stationary object component 214 to determine, identify, and/or classify stationary objects as DPVs. In such instances, the DPV identifying component 204 may determine whether and/or to what degree the stationary vehicle(s) are located within a lane adjacent to the side of the road. For instance, a stationary object may be considered a DPV if more than a threshold amount or percentage of the lane is covered by the stationary object. Additionally and/or alternatively, a stationary object may be considered a DPV if a distance from a side of the object to a lane marker is less than a threshold distance (e.g., less than the width of an oncoming or approaching object). In such cases, the DPV identifying component 204 may identify one or more DPVs located in the same driving lane as the vehicle and/or located in a laterally adjacent driving lane.

In some examples, the planning component 202 may include a heatmap component 206 configured to determine one or more weighted heatmaps. As shown, the heatmap component 206 may include a dimensions component 224 configured to determine the dimensions and/or location of the heatmap. For example, the dimensions of the heatmap may include a length and/or width element. The dimensions component 224 may determine that the length of the heatmap corresponds to a length of the DPV plus a buffer. Further, the dimensions component 224 may determine that the width of the heatmap corresponds to a width of the DPV plus a buffer. In some examples, the dimensions component 224 may generate the heatmap such that that the heatmap is centered on the DPV. In some examples, the heatmap may be aligned with the longest edges of the heatmap extending parallel to a lateral side of the DPV. However, in other examples, the heatmap may be aligned with the shape of the roadway and not parallel to the lateral sides of the DPV (e.g., the heatmap may curve with the shape of the driving lane). As indicated above, the heatmap may include a weight value which may be used to determine one or more cost values.

In some examples, the planning component 202 may include a candidate action generating component 210 configured to generate candidate actions for the vehicle to follow. The candidate action generating component 210 may receive sensor data indicative of the current driving scenario. The candidate action generating component 210 may use such sensor data to generate candidate actions (or trajectories) through the environment. As shown, the candidate action generating component 210 may send candidate action data to the cost determining component 208.

In some examples, the planning component 202 may include a cost determining component 208 configured to determine the cost of candidate trajectories. The cost determining component 208 may receive the candidate actions from the candidate action generating component 210 and/or any other component of the planning component 202. In some examples, the cost determining component 208 may generate a tree structure that includes some or all of the trajectories. The purpose of the tree structure is to enable the vehicle to evaluate the candidate actions at each state of the vehicle and to determine a control trajectory for the vehicle to follow based on such candidate trajectories. The tree structure may include an initial node (e.g., root node) which represents the state of the vehicle. Multiple candidate actions may extend from the initial node. In such instances, the cost determining component 208 may determine a traversal path based on the candidate actions that results in the traversal path having a lowest determined overall cost. To determine the lowest overall cost, the cost determining component 208 may determine one or more sub-costs that may be combined into the overall cost.

As shown, the cost determining component 208 may include one or more subcomponents such as the vehicle and heatmap overlap component 226 and the velocity component 228. In some examples, the vehicle and heatmap overlap component 226 may be configured to determine an amount of overlap between the body of the vehicle and the heatmap. For example, the vehicle and heatmap overlap component 226 may receive a candidate action and identify (or determine) a vehicle state along the candidate action. In such cases, when determining a cost associated with the vehicle state, the vehicle and heatmap overlap component 226 may determine, at the vehicle state, an amount of the vehicle body that is located within the heatmap boundary. For example, if half of the vehicle body is within (or otherwise overlaps with) the heatmap, the amount may be 50%. As indicated above, the cost determining component 208 may use the amount of vehicle overlap to determine a cost. The cost determining component 208 may determine the cost by performing Equation 1 and/or 2 described above.

In some examples, the velocity component 228 may be configured to determine velocity values of the vehicle at certain vehicle states and use such data to determine the cost. That is, the velocity component 228 may determine, for a specific vehicle state along a candidate action, a velocity of the vehicle. Based on determining the vehicle velocity at the vehicle state, the velocity component may determine a velocity limit (or speed limit) of the roadway (or driving lane) within which the vehicle is located. Based on determining the vehicle velocity and the velocity limit, the cost determining component 208 may perform Equation 2 to determine a cost value to be used when evaluating the candidate actions.

In some examples, the planning component 202 may include a trajectory determining component 212 configured to select or otherwise determine a candidate trajectory to follow. In such instances, the trajectory determining component 212 may determine a control trajectory for the vehicle to follow based on a combination of the lowest cost candidate actions. That is, the vehicle may determine to follow a control trajectory that has the lowest overall cost compared to the overall costs of the other potential traversal paths between the candidate trajectories. The trajectory determining component 212 may send the trajectory 230 to the vehicle 232 for the vehicle 232 to follow. In such instances, upon receiving the trajectory 230, the vehicle 232 may be controlled, based on the instructions included in the trajectory 230, to follow the trajectory 230 throughout the environment.

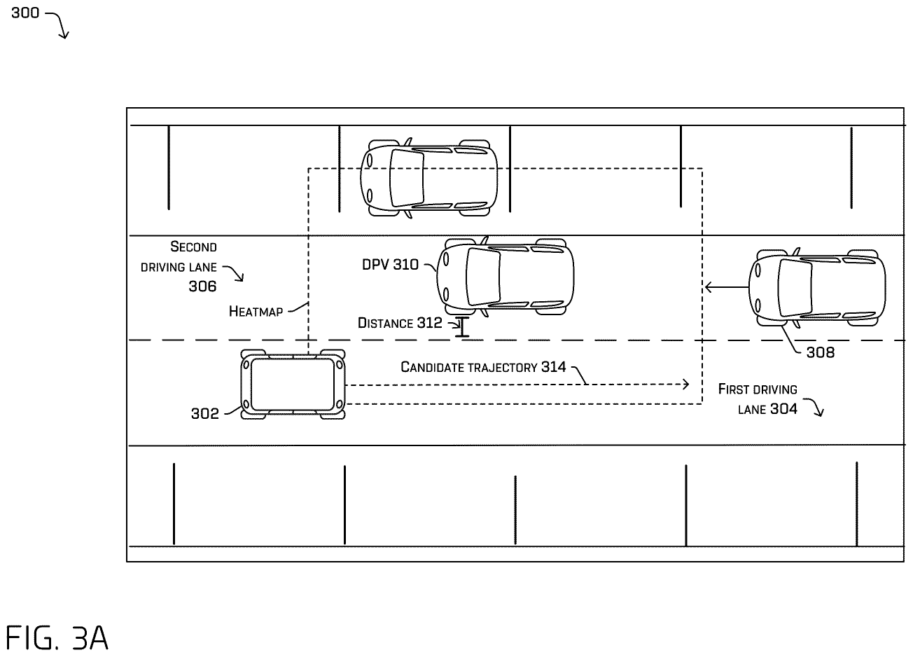

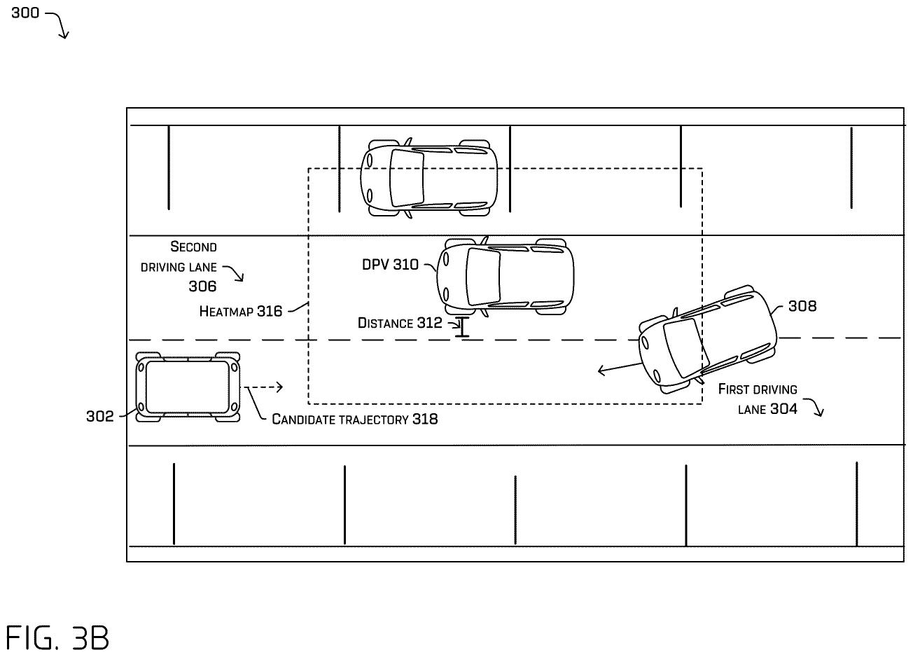

FIGS. 3A and 3B illustrate an example environment 300 including a weighted heatmap surrounding a DPV.

FIG. 3A illustrates an example environment 300 that includes a weighted heatmap and a DPV blocking the path of an oncoming object.

In this example, the example environment 300 may be similar or identical to the environment illustrated and/or described in FIGS. 1 and 2. As shown, the example environment 300 may include a vehicle 302 navigating along a road in a first driving lane 304. As shown, the example environment 300 may include an object 308 navigating in a second driving lane 306 that corresponds to an opposite direction of travel as compared to the direction of travel of the vehicle 302. In this example, the object 308 may be a vehicle; however, in other examples, the object 308 may be any other type of dynamic object.

Further, the example environment 300 may include a DPV 310 located within the second driving lane 306. In this case, the vehicle 302 may determine that the DPV 310 is a stationary vehicle parked at least partially within the second driving lane 306. The vehicle 302 may determine that the DPV 310 is a DPV based on the distance 312 from a side of the DPV 310 to the lane marker being below a threshold distance. In this case, the threshold distance may be the width of the object 308. As shown in this example, the distance 312 may be less than the width of the object 308 and as such, the DPV 310 may be blocking the progress of the object 308. That is, the object 308 may be forced to wait behind the DPV 310 or exit the second driving lane 306 in order to make progress to its destination.

As shown, the vehicle 302 may generate a candidate trajectory 314 for the vehicle 302 to follow. The candidate trajectory 314 may instruct the vehicle 302 to continue through the potential blocking region. Based on generating the candidate trajectory 314, the vehicle may determine whether to follow the candidate trajectory 314 by determining an overall cost for the candidate trajectory 314. As described above, the vehicle 302 may determine multiple different cost values associated with the candidate trajectory 314. One of the costs may be a lane blocking cost or a DPV-related cost. In this example, the vehicle 302 may determine the cost by generating a heatmap 316 that surrounds (or encompasses) the DPV 310, determining an amount of the vehicle 302 that overlaps with the heatmap 316, and using the amount and the weight associated with the heatmap 316 in Equation 1 and/or 2. The result of Equation 1 and/or 2 may be a sub-cost that is used to determine the overall cost for the candidate trajectory 314. The vehicle 302 may use the overall cost to determine which of the one or more candidate trajectories to follow.

FIG. 3B illustrates the example environment 300 that includes a weighted heatmap and the object 308 laterally nudging around the DPV 310 causing the vehicle 302 to stop prior to entering the heatmap region.

In this example, the example environment 300 may be similar or identical to the environment illustrated and/or described in FIGS. 1-3A. As shown, the example environment 300 may include a vehicle 302 navigating along a road in a first driving lane 304. As shown, the example environment 300 may include an object 308 navigating between the second driving lane 306 and the first driving lane 304. Importantly, the second driving lane 306 corresponds to an opposite direction of travel as compared to the direction of travel of the vehicle 302. Similar to FIG. 3A, the object 308 may be a vehicle; however, in other examples, the object 308 may be any other type of dynamic object.

Further, the example environment 300 may include a DPV 310 located within the second driving lane 306. In this case, the vehicle 302 may determine that the DPV 310 is a stationary vehicle parked at least partially within the second driving lane 306. The vehicle 302 may determine that the DPV 310 is a DPV based on the distance 312 from a side of the DPV 310 to the lane marker being below a threshold distance. In this case, the threshold distance may be the width of the object 308. As shown in this example, the distance 312 may be less than the width of the object 308 and as such, the DPV 310 may be blocking the progress of the object 308. That is, the object 308 may be forced to wait behind the DPV 310 or exit the second driving lane 306 in order to make progress to its destination.

As shown, the vehicle 302 may generate a candidate trajectory 318 for the vehicle 302 to follow. The candidate trajectory 318 may instruct the vehicle 302 to stop prior to the potential blocking region. Based on generating the candidate trajectory 318, the vehicle may determine whether to follow the candidate trajectory 318 by determining an overall cost for the candidate trajectory 318. As described above, the vehicle 302 may determine multiple different cost values associated with the candidate trajectory 318. One of the costs may be a lane blocking cost or a DPV-related cost. In this example, the vehicle 302 may determine the cost by generating a heatmap 316 that surrounds (or encompasses) the DPV 310, determining an amount of the vehicle 302 that overlaps with the heatmap 316, and using the amount and the weight associated with the heatmap 316 in Equation 1 and/or 2. The result of Equation 1 and/or 2 may be a sub-cost that is used to determine the overall cost for the candidate trajectory 318. The vehicle 302 may use the overall cost to determine which of the one or more candidate trajectories to follow. In this case, the overall cost of the candidate trajectory 318 may instruct the vehicle 302 to wait at a location before the heatmap 316 such that the object 308 has sufficient space to navigate around the DPV 310. Additionally or alternatively, the vehicle 302 may also determine to follow a candidate action that laterally biases to a right side of the first driving lane 304 such that the object 308 is capable of navigating within the first driving lane 304.

FIG. 4 illustrates an example environment 400 include multiple weighted heatmaps that are merged into a single heatmap.

In this example, the example environment 400 may be similar or identical to the environment illustrated and/or described in FIGS. 1 and 2. As shown, the example environment 400 may include a vehicle 402 navigating along a road in a first driving lane 404. As shown, the example environment 400 may include an object 408 navigating in a second driving lane 406 that corresponds to an opposite direction of travel compared to the direction of travel of the vehicle 402. In this example, the object 408 may be a vehicle; however, in other examples, the object 408 may be any other type of dynamic object.

Further, the example environment 400 may include a DPV 410 located within the second driving lane 406 and a DPV 412 located within the first driving lane 404. As shown, the DPV 410 and the DPV 412 may be vehicles; however, in other examples, the DPVs may be any other type of static or dynamic object. In this example, the vehicle 402 may generate a single heatmap for each DPV or a single heatmap for all of the DPVs. For example, in some instances, the vehicle 402 may generate a heatmap 414 for the DPV 410 and a heatmap 416 for the DPV 412. In such cases, the heatmap 414 and the heatmap 416 may have the same or different weights encoded therein. Additionally or alternatively, the vehicle 402 may combine or merge the heatmap 414 and the heatmap 416 such that the heatmaps are a single heatmap with a single weight encoded therein. The weight of the merged heatmap may be an average of the two heatmaps, a highest weight between the two heatmaps, etc. Based on determining the heatmap(s), the vehicle 402 may use the heatmap(s) to generate cost(s) associated with following such trajectories through the environment. The vehicle 402 may generate the costs using similar or identical techniques described above (e.g., Equations 1 and/or 2).

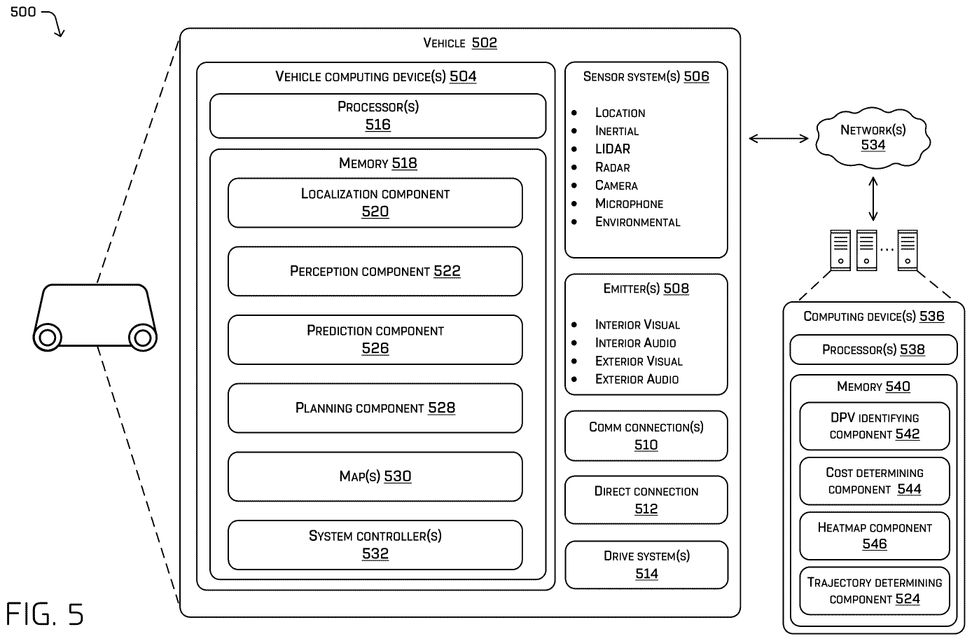

FIG. 5 is a block diagram of an example system 500 for implementing the techniques described herein. In at least one example, the system 500 may include a vehicle, such as vehicle 502. The vehicle 502 may include one or more vehicle computing devices 504, one or more sensor systems 506, one or more emitters 508, one or more communication connections 510, at least one direct connection 512, and one or more drive systems 514.

The vehicle computing device 504 may include one or more processors 516 and memory 518 communicatively coupled with the processor(s) 516. In the illustrated example, the vehicle 502 is an autonomous vehicle; however, the vehicle 502 could be any other type of vehicle, such as a semi-autonomous vehicle, or any other system having at least an image capture device (e.g., a camera-enabled smartphone). In some instances, the autonomous vehicle 502 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the autonomous vehicle 502 may be a fully or partially autonomous vehicle having any other level or classification.

In the illustrated example, the memory 518 of the vehicle computing device 504 stores a localization component 520, a perception component 522, a prediction component 526, a planner component 528, one or more system controllers 532, and one or more maps 530 (or map data). Though depicted in FIG. 5 as residing in the memory 518 for illustrative purposes, it is contemplated that the localization component 520, the perception component 522, the prediction component 526, the planner component 528, system controller(s) 532, and/or the map(s) may additionally, or alternatively, be accessible to the vehicle 502 (e.g., stored on, or otherwise accessible by, memory remote from the vehicle 502, such as, for example, on memory 540 of one or more computing device 536). In some examples, the memory 540 may include a DPV identifying component 542, a cost determining component 544, a heatmap component 546, and/or a trajectory determining component 524.

In at least one example, the localization component 520 may include functionality to receive sensor data from the sensor system(s) 506 to determine a position and/or orientation of the vehicle 502 (e.g., one or more of an x-, y-, z-position, roll, pitch, or yaw). For example, the localization component 520 may include and/or request/receive a map of an environment, such as from map(s) 530, and may continuously determine a location and/or orientation of the vehicle 502 within the environment. In some instances, the localization component 520 may utilize SLAM (simultaneous localization and mapping), CLAMS (calibration, localization and mapping, simultaneously), relative SLAM, bundle adjustment, non-linear least squares optimization, or the like to receive image data, lidar data, radar data, inertial measurement unit (IMU) data, GPS data, wheel encoder data, and the like to accurately determine a location of the vehicle 502. In some instances, the localization component 520 may provide data to various components of the vehicle 502 to determine an initial position of the vehicle 502 for determining the relevance of an object to the vehicle 502, as discussed herein.

In some instances, the perception component 522 may include functionality to perform object detection, segmentation, and/or classification. In some examples, the perception component 522 may provide processed sensor data that indicates a presence of an object (e.g., entity) that is proximate to the vehicle 502 and/or a classification of the object as an object type (e.g., car, pedestrian, cyclist, animal, building, tree, road surface, curb, sidewalk, unknown, etc.). In some examples, the perception component 522 may provide processed sensor data that indicates a presence of a stationary entity that is proximate to the vehicle 502 and/or a classification of the stationary entity as a type (e.g., building, tree, road surface, curb, sidewalk, unknown, etc.). In additional or alternative examples, the perception component 522 may provide processed sensor data that indicates one or more features associated with a detected object (e.g., a tracked object) and/or the environment in which the object is positioned. In some examples, features associated with an object may include, but are not limited to, an x-position (global and/or local position), a y-position (global and/or local position), a z-position (global and/or local position), an orientation (e.g., a roll, pitch, yaw), an object type (e.g., a classification), a velocity of the object, an acceleration of the object, an extent of the object (size), etc. Features associated with the environment may include, but are not limited to, a presence of another object in the environment, a state of another object in the environment, a time of day, a day of a week, a season, a weather condition, an indication of darkness/light, etc.

The prediction component 526 may generate one or more probability maps representing prediction probabilities of possible locations of one or more objects in an environment. For example, the prediction component 526 may generate one or more probability maps for vehicles, pedestrians, animals, and the like within a threshold distance from the vehicle 502. In some instances, the prediction component 526 may measure a track of an object and generate a discretized prediction probability map, a heat map, a probability distribution, a discretized probability distribution, and/or a trajectory for the object based on observed and predicted behavior. In some instances, the one or more probability maps may represent an intent of the one or more objects in the environment.

In some examples, the prediction component 526 may generate predicted trajectories of objects (e.g., objects) in an environment. For example, the prediction component 526 may generate one or more predicted trajectories for objects within a threshold distance from the vehicle 502. In some examples, the prediction component 526 may measure a trace of an object and generate a trajectory for the object based on observed and predicted behavior.

In general, the planner component 528 may determine a path for the vehicle 502 to follow to traverse through an environment. For example, the planner component 528 may determine various routes and trajectories and various levels of detail. For example, the planner component 528 may determine a route to travel from a first location (e.g., a current location) to a second location (e.g., a target location). For the purpose of this discussion, a route may include a sequence of waypoints for travelling between two locations. As non-limiting examples, waypoints include streets, intersections, global positioning system (GPS) coordinates, etc. Further, the planner component 528 may generate an instruction for guiding the vehicle 502 along at least a portion of the route from the first location to the second location. In at least one example, the planner component 528 may determine how to guide the vehicle 502 from a first waypoint in the sequence of waypoints to a second waypoint in the sequence of waypoints. In some examples, the instruction may be a candidate trajectory, or a portion of a trajectory. In some examples, multiple trajectories may be substantially simultaneously generated (e.g., within technical tolerances) in accordance with a receding horizon technique. A single path of the multiple paths in a receding data horizon having the highest confidence level may be selected to operate the vehicle. In various examples, the planner component 528 may select a trajectory for the vehicle 502.

In other examples, the planner component 528 may alternatively, or additionally, use data from the localization component 520, the perception component 522, and/or the prediction component 526 to determine a path for the vehicle 502 to follow to traverse through an environment. For example, the planner component 528 may receive data (e.g., object data) from the localization component 520, the perception component 522, and/or the prediction component 526 regarding objects associated with an environment. In some examples, the planner component 528 receives data for relevant objects within the environment. Using this data, the planner component 528 may determine a route to travel from a first location (e.g., a current location) to a second location (e.g., a target location) to avoid objects in an environment. In at least some examples, such a planner component 528 may determine there is no such collision-free path and, in turn, provide a path that brings vehicle 502 to a safe stop avoiding all collisions and/or otherwise mitigating damage. Further, the planning component 528 may perform any of the techniques described above with respect to any of FIGS. 1-4 with respect to generating vehicle actions proximate DPV(s) that increase traffic flow and/or decrease the likelihood of collision.

In at least one example, the vehicle computing device 504 may include one or more system controllers 532, which may be configured to control steering, propulsion, braking, safety, emitters, communication, and other systems of the vehicle 502. The system controller(s) 532 may communicate with and/or control corresponding systems of the drive system(s) 514 and/or other components of the vehicle 502.

The memory 518 may further include one or more maps 530 that may be used by the vehicle 502 to navigate within the environment. For the purpose of this discussion, a map may be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map may include a three-dimensional mesh of the environment. In some examples, the vehicle 502 may be controlled based at least in part on the map(s) 530. That is, the map(s) 530 may be used in connection with the localization component 520, the perception component 522, the prediction component 526, and/or the planner component 528 to determine a location of the vehicle 502, detect objects in an environment, generate routes, determine actions and/or trajectories to navigate within an environment.

In some examples, the one or more maps 530 may be stored on a remote computing device(s) (such as the computing device(s) 536) accessible via network(s) 534. In some examples, multiple maps 530 may be stored based on, for example, a characteristic (e.g., type of entity, time of day, day of week, season of the year, etc.). Storing multiple maps 530 may have similar memory requirements, but increase the speed at which data in a map may be accessed.

In some instances, aspects of some or all of the components discussed herein may include any models, techniques, and/or machine-learned techniques. For example, in some instances, the components in the memory 518 (and the memory 540, discussed below) may be implemented as a neural network.

As described herein, an exemplary neural network is a technique which passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID3), Chi-squared automatic interaction detection (CHAID), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

Additional examples of architectures include neural networks such as ResNet-50, ResNet-101, VGG, DenseNet, PointNet, Xception, ConvNeXt, and the like; visual transformer(s) (ViT(s)), such as a bidirectional encoder from image transformers (BEIT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. patent application Ser. No. 15/963,833, which is incorporated by reference in its entirety herein for all purposes), and/or VoxelNet. Architecture latency optimizations may include MobilenetV2, Shufflenet, Channelnet, Peleenet, and/or the like. The ML model may comprise a residual block such as Pixor, in some examples.

In at least one example, the sensor system(s) 506 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), etc. The sensor system(s) 506 may include multiple instances of each of these or other types of sensors. For instance, the lidar sensors may include individual lidar sensors located at the corners, front, back, sides, and/or top of the vehicle 502. As another example, the camera sensors may include multiple cameras disposed at various locations about the exterior and/or interior of the vehicle 502. The sensor system(s) 506 may provide input to the vehicle computing device 504. Additionally, or in the alternative, the sensor system(s) 506 may send sensor data, via the one or more networks 534, to the one or more computing device(s) 536 at a particular frequency, after a lapse of a predetermined period of time, in near real-time, etc.

The vehicle 502 may also include one or more emitters 508 for emitting light and/or sound. The emitter(s) 508 may include interior audio and visual emitters to communicate with passengers of the vehicle 502. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 508 may also include exterior emitters. By way of example and not limitation, the exterior emitters may include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 502 may also include one or more communication connections 510 that enable communication between the vehicle 502 and one or more other local or remote computing device(s). For instance, the communication connection(s) 510 may facilitate communication with other local computing device(s) on the vehicle 502 and/or the drive system(s) 514. Also, the communication connection(s) 510 may allow the vehicle to communicate with other nearby computing device(s) (e.g., computing device 536, other nearby vehicles, etc.) and/or one or more remote sensor system(s) for receiving sensor data. The communications connection(s) 510 also enable the vehicle 502 to communicate with a remote teleoperations computing device or other remote services.

The communications connection(s) 510 may include physical and/or logical interfaces for connecting the vehicle computing device 504 to another computing device or a network, such as network(s) 534. For example, the communications connection(s) 510 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

In at least one example, the vehicle 502 may include one or more drive systems 514. In some examples, the vehicle 502 may have a single drive system 514. In at least one example, if the vehicle 502 has multiple drive systems 514, individual drive systems 514 may be positioned on opposite ends of the vehicle 502 (e.g., the front and the rear, etc.). In at least one example, the drive system(s) 514 may include one or more sensor systems to detect conditions of the drive system(s) 514 and/or the surroundings of the vehicle 502. By way of example and not limitation, the sensor system(s) may include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, lidar sensors, radar sensors, etc. Some sensors, such as the wheel encoders may be unique to the drive system(s) 514. In some cases, the sensor system(s) on the drive system(s) 514 may overlap or supplement corresponding systems of the vehicle 502 (e.g., sensor system(s) 506).

The drive system(s) 514 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 514 may include a drive module controller which may receive and preprocess data from the sensor system(s) and to control operation of the various vehicle systems. In some examples, the drive module controller may include one or more processors and memory communicatively coupled with the one or more processors. The memory may store one or more modules to perform various functionalities of the drive system(s) 514. Furthermore, the drive system(s) 514 may also include one or more communication connection(s) that enable communication by the respective drive module with one or more other local or remote computing device(s).

In at least one example, the direct connection 512 may provide a physical interface to couple the one or more drive system(s) 514 with the body of the vehicle 502. For example, the direct connection 512 may allow the transfer of energy, fluids, air, data, etc. between the drive system(s) 514 and the vehicle. In some instances, the direct connection 512 may further releasably secure the drive system(s) 514 to the body of the vehicle 502.

In at least one example, the localization component 520, the perception component 522, the prediction component 526, the planner component 528, the one or more system controllers 532, and the one or more maps 530 may process sensor data, as described above, and may send their respective outputs, over the one or more network(s) 534, to the computing device(s) 536. In at least one example, the localization component 520, the perception component 522, the prediction component 526, the planner component 528, the one or more system controllers 532, and the one or more maps 530 may send their respective outputs to the computing device(s) 536 at a particular frequency, after a lapse of a predetermined period of time, in near real-time, etc.

In some examples, the vehicle 502 may send sensor data to the computing device(s) 536 via the network(s) 534. In some examples, the vehicle 502 may receive sensor data from the computing device(s) 536 and/or remote sensor system(s) via the network(s) 534. The sensor data may include raw sensor data and/or processed sensor data and/or representations of sensor data. In some examples, the sensor data (raw or processed) may be sent and/or received as one or more log files.

The computing device(s) 536 may include processor(s) 538 and a memory 540, which may include a DPV identifying component 542, a cost determining component 544, a heatmap component 546, and/or a trajectory determining component 524. In some examples, the memory 540 may store one or more of components that are similar to the component(s) stored in the memory 518 of the vehicle 502. In such examples, the computing device(s) 536 may be configured to perform one or more of the processes described herein with respect to the vehicle 502. In some examples, the DPV identifying component 542, the cost determining component 544, the heatmap component 546, and/or the trajectory determining component 524 may perform substantially similar functions as the planning component 528.

The processor(s) 516 of the vehicle 502 and the processor(s) 538 of the computing device(s) 536 may be any suitable processor capable of executing instructions to process data and perform operations as described herein. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 518 and memory 540 are examples of non-transitory computer-readable media. The memory 518 and memory 540 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

It should be noted that while FIG. 5 is illustrated as a distributed system, in alternative examples, components of the vehicle 502 may be associated with the computing device(s) 536 and/or components of the computing device(s) 536 may be associated with the vehicle 502. That is, the vehicle 502 may perform one or more of the functions associated with the computing device(s) 536, and vice versa. The methods described herein represent sequences of operations that may be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes. In some examples, one or more operations of the method may be omitted entirely. For instance, the operations may include determining a first action and a second action by the vehicle relative to a selected trajectory without determining a respective cost for one or more of the actions by the vehicle. Moreover, the methods described herein may be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

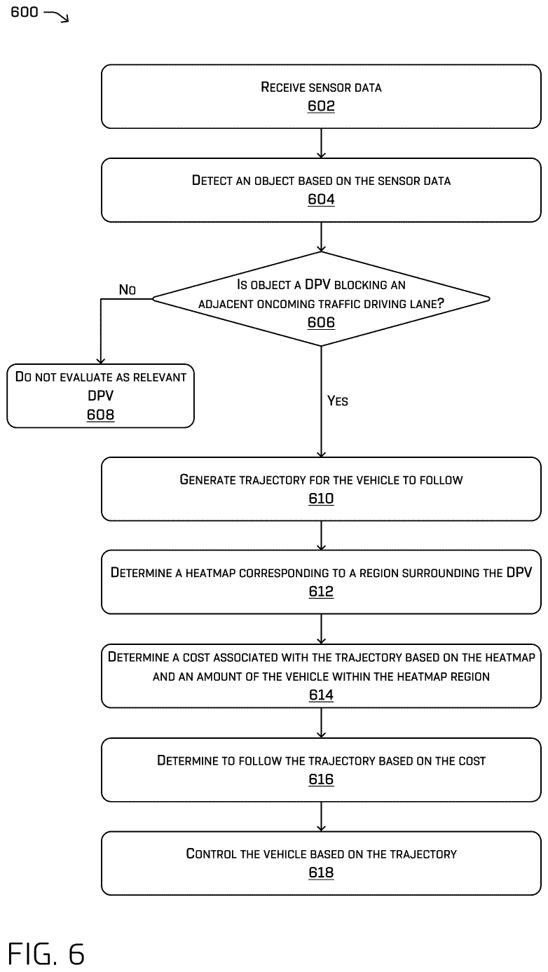

FIG. 6 is a flow diagram illustrating an example process 600 for detecting a double-parked vehicle, determining a heatmap surrounding the double-parked vehicle, generating cost(s) for a candidate action based on the heatmap, determining to follow the candidate action based on the cost, and controlling the vehicle based on the candidate action. As described below, the process 600 may be performed by one or more computer-based components configured to implement various functionalities described herein. For instance, some or all of the operations of process 600 may be performed by a planning component 202. As described above, a planning component 202 may be integrated as an on-vehicle system in some examples. However, in other examples, the planning component 202 may be integrated as a separate server-based system.

Process 600 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 602, the planning component may receive sensor data. That is, the vehicle may capture sensor data while navigating an environment. The vehicle may include one or more sensor device(s) (e.g., lidar device(s), radar device(s), time-of-flight device(s), image capturing device(s), etc.) located or mounted at various positions within or on the vehicle body. In such cases, the sensor device(s) may capture sensor data of the environment proximate the vehicle.

At operation 604, the planning component may detect an object based on the sensor data. That is, the vehicle may analyze the sensor data and identify one or more object(s) within the environment. For example, the sensor data may include one or more static and/or dynamic objects such as other vehicle(s) (e.g., cars, trucks, motorcycles, cyclists, etc.), pedestrians, animals, stationary object(s) (e.g., dynamic objects that have a velocity of zero), trees, bushes, buildings, signage, road markings, etc. The vehicle may detect the object(s) using one or more machine-learned models. In some examples, the object(s) may include various types of object data (or object features) such as a classification (or type), a pose (e.g., position (e.g., x- and y-coordinate) and/or heading (or yaw)), a size, a velocity, an acceleration, a track (or history), etc. Further, the vehicle may determine that the object is a stationary object based at least in part on determining a stationary intent (e.g., the object is predicted to remain stationary) and/or a velocity below a threshold level. Example techniques for detecting or otherwise determining stationary objects can be found, for example, in U.S. Pat. No. 11,188,082, filed Jan. 11, 2019, and titled “Occlusion Prediction and Trajectory Evaluation,” as well as in U.S. Pat. No. 10,955,851, filed Feb. 14, 2018, and titled “Detecting Blocking Objects” the contents of which is herein incorporated by reference in its entirety and for all purposes.

At operation 606, the planning component may determine whether the object is a DPV blocking an adjacent oncoming driving lane. A DPV may be a blocking vehicle, a parked (e.g., velocity below a threshold value) vehicle laterally adjacent to an already parked vehicle along the side of a road, and/or a parked vehicle proximate the side of a road without a laterally adjacent parked vehicle. In some examples, the vehicle may determine that a stationary object is a DPV based on a distance from a side of the stationary object to a lane marker being below a threshold amount (e.g., using map data (e.g., road network data)). The threshold amount may be determined based on a classification and/or type of an object approaching the DPV in the same driving lane as the DPV. That is, the threshold may be based on a width of the approaching object that is longitudinally behind the DPV. If the distance is below the threshold, the vehicle may determine that the DPV is sufficiently within the driving lane and that the approaching object is unable to travel past the DPV without exiting the current driving lane. As such, if the object is not a DPV (606: No), the vehicle may determine that the object is not a DPV to consider while navigating the environment. That is, at operation 608, the planning component may not evaluate the object as a relevant DPV.

In contrast, if the object is a DPV (606: Yes), the vehicle may determine costs for trajectories using a heatmap surrounding the DPV object. For example, at operation 610, the planning component may generate a trajectory for the vehicle to follow. A candidate action may be a trajectory that includes a spatial representation of future movements of the vehicle in addition to one or more vehicle controls (or control data) (e.g., velocity, acceleration, yaw, steering angle, etc.). That is, the candidate actions may include instructions that instruct the vehicle how to navigate a portion of the environment. The candidate actions can include instructions that cause the vehicle to perform one or more actions, such as remain in the same lane, lane change left, lane change right, pass an object proximate the vehicle, modify vehicle kinematics (e.g., velocity, acceleration, etc.), and/or any other type of action. In some examples, a candidate action may include multiple predicted states that can represent the state information of the vehicle at a specific location along the candidate action. State information may include location data, pose data (e.g., lateral offset data, longitudinal offset data, heading offset data), velocity data, acceleration data, and/or other types of data. Examples of various techniques for generating planner actions (or trajectories) for autonomous vehicles can be found, for example, in U.S. Pat. No. 10,921,811, filed on Jan. 22, 2018, issued on Feb. 16, 2021, and titled, “Adaptive Autonomous Vehicle Planner Logic,” in U.S. patent application Ser. No. 18/540,642, filed Dec. 14, 2023, and titled “Machine-Learned Cost Estimation in Tree Search Trajectory Generation for Vehicle Control,” in U.S. Pat. No. 11,875,678, filed on Jan. 21, 2021 and issued on Jan. 16, 2024, and titled “Unstructured Vehicle Path Planner,” and in U.S. Pat. No. 10,955,851, filed on Feb. 14, 2018, issued on Mar. 23, 2021, and titled, “Detecting Blocking Objects,” each of which is incorporated by reference herein in its entirety and for all purposes.

At operation 612, the planning component may determine a heatmap corresponding to a region surrounding the DPV. A heatmap may correspond to a physical region of the environment and may include a weighted value. In some cases, one or more vehicle components may determine the weighted heatmap(s) during a pre-computation stage and/or by a remote server-based system. For example, a pre-computation stage may be a moment in which the vehicle turns on, initializes, and/or any other situation. As such, the planning component may receive, request, and/or determine the previously generated heatmap(s) when approaching a DPV. Generating the weighted heatmaps during a pre-computation stage may improve computational efficiency by reducing the amount of processing for the vehicle to perform in real-time scenarios.

In some examples, the vehicle component(s) may determine the heatmap dimensions based on attributes of the DPV and/or any approaching object(s) in the same driving lane as the DPV. For example, the vehicle component(s) may generate the heatmap such that the heatmap is centered around the DPV. The length of the heatmap may be the length of the DPV plus a buffer and the width of the heatmap may be the width of the DPV plus a buffer. Additionally or alternatively, the length and/or width of the heatmap may also be based on an orientation of the DPV within the driving lane, a velocity of the vehicle (e.g., increase the length of the heatmap to account for the increased velocity), semantic information regarding the environment (such as lane width, traffic signs, etc.), a predicted acceleration and/or predicted acceleration capability of the DPV, etc. In such cases, the vehicle may generate a single heatmap for a DPV. Additionally or alternatively, in situations in which there are multiple DPVs, the vehicle may merge the multiple heatmaps of the multiple DPVs into a single heatmap. In some examples, the heatmap may be determined with respect to a global or local coordinate system and as such, the various regions (and/or edges) of the heatmap may correspond to geographical coordinates.

At operation 614, the planning component may determine a cost associated with the trajectory based on the heatmap and an amount of the vehicle within the heatmap region. In some examples, the planning component may generate a control trajectory which may be a combination of the one or more candidate actions. For instance, to determine which of the one or more candidate actions to follow, the planning component may use a tree structure. Accordingly, the planning component may generate a tree structure that includes some or all of the candidate actions. A tree structure may include one or more nodes representing vehicle states at different action layers of the tree structure. Further, each vehicle state may include multiple candidate actions which the vehicle may follow. As described in more detail below, the planning component may use the tree structure to determine or otherwise select one or more of the candidate actions to follow from a node in the tree structure to a different node at the next layer of the tree structure. The planning component may determine which candidate actions to follow between layers of nodes based on one or more costs. Example techniques for generating a tree structure and determining a control trajectory based on the tree structure can be found, for example, in U.S. application Ser. No. 17/900,658, filed Aug. 21, 2022, and titled “Trajectory Prediction Based on a Decision Tree,” the content of which is herein incorporated by reference in its entirety and for all purposes.

In some examples, the planning component can determine a control trajectory based on the tree structure. The planning component can evaluate some or all candidate actions when determining a control trajectory. A solution to the tree may result in a series of nodes of the one or more candidate actions which, when traversed (e.g., moving along and between differing trajectories and/or action layers of the tree structure), results in a control trajectory (e.g., output trajectory) having a lowest determined overall cost. An overall cost for the control trajectory may represent and/or be indicative of the combination of one or more sub-costs. A cost value can indicate the safety, progress, comfort, risk, convenience, and/or efficiency of a candidate trajectory. For instance, a high cost value may indicate heightened degree of risk, danger, inconvenience, discomfort, and/or inefficiency of the trajectory. In contrast, a low cost value may indicate a lower degree of risk, danger, inconvenience, and/or inefficiency of the trajectory. In some examples, sub-costs may include comfort-related costs (e.g., acceleration cost, jerk cost, steering cost, path reference cost, etc.), legality-related costs, policy-related costs, safety-related costs (e.g., lane changing costs), progress costs, debris cost, a lane blocking cost, a lane ending cost, an exit cost, an approach cost, a space cost, a payment cost, a yaw cost, adversarial cost(s), lane targeting cost (e.g., cost associated with the vehicle being located in a desired lane), cyclist-related cost(s), DPV passing cost, and/or any other type of cost.

In some examples, when determining a DPV passing cost or lane blocking cost, the vehicle may determine such costs using the heatmap. That is, the vehicle may use the heatmap to determine a sub-cost for some or all of the candidate actions. When determining the sub-cost, the vehicle may perform one or more of Equation 1 or Equation 2 as described above.

At operation 616, the planning component may determine to follow the trajectory based on the cost. Upon determining the sub-cost(s), the planning component may determine or otherwise combine the sub-costs into a single overall cost. In some examples, the vehicle may determine to follow a control trajectory that has the lowest overall cost compared to the overall costs of other potential traversal paths between the candidate trajectories.

At operation 618, the planning component may control the vehicle based on the trajectory. In some examples, the vehicle may follow the control trajectory while operating within the environment. Upon determining the control trajectory from the tree search, the vehicle may follow the control trajectory throughout the environment. As such, the vehicle may be controlled based on the sub-cost(s).

### EXAMPLE CLAUSES

A: A system comprising: one or more processors; and one or more non-transitory computer-readable media storing computer-executable instructions that, when executed, cause the system to perform operations comprising: receiving, from a sensor device associated with an autonomous vehicle, sensor data representative of an environment; detecting, based at least in part on the sensor data, an object; determining that the object is a stationary vehicle in a laterally adjacent driving lane; determining, based at least in part on the object being the stationary vehicle, a heatmap associated with a first region of the environment that encompasses the object; determining a candidate action for the autonomous vehicle to follow; determining, based at least in part on the candidate action, a future state of the autonomous vehicle; determining, based at least in part on the future state of the autonomous vehicle, an overlap portion between a second region occupied by the autonomous vehicle at the future state and the first region of the heatmap; determining, based at least in part on the heatmap and the overlap portion, a cost of following the candidate action; and controlling the autonomous vehicle based at least in part on the cost.

B: The system of paragraph A, wherein determining that the object is the stationary vehicle comprises: determining a distance from a side of the object to a lane marker; and determining that the distance is less than a threshold distance.

C: The system of paragraph B, wherein the object is a first object, wherein the threshold distance is determined based at least in part on a classification of a second object that is different than the first object.

D: The system of paragraph A, wherein determining the cost comprises: determining a weight associated with the heatmap, wherein the cost is determined based at least in part on a combination of the weight and the overlap portion of the autonomous vehicle in the first region.

E: The system of paragraph A, wherein determining the cost comprises: determining a velocity of the autonomous vehicle; and determining a velocity limit of a driving lane associated with the autonomous vehicle, wherein the cost is determined based at least in part on a combination of the overlap portion of the autonomous vehicle in the first region, the velocity of the autonomous vehicle, and the velocity limit.

F: One or more non-transitory computer-readable media storing instructions executable by one or more processors, wherein the instructions, when executed, cause a system to perform operations comprising: receiving sensor data representative of an environment; detecting, based at least in part on the sensor data, an object; determining a heatmap associated with a first region of the environment that encompasses the object; determining a candidate action for a vehicle to follow; determining, based at least in part on the candidate action, a future state of the vehicle; determining, based at least in part on the future state of the vehicle, an overlap portion between a second region occupied by the vehicle at the future state and the first region of the heatmap; and determining, based at least in part on the heatmap and the overlap portion, a cost of following the candidate action.

G: The one or more non-transitory computer-readable media of paragraph F, wherein determining the cost comprises: determining a weight associated with the heatmap, wherein the cost is determined based at least in part on a combination of the weight and the overlap portion of the vehicle in the first region.

H: The one or more non-transitory computer-readable media of paragraph F, wherein determining the cost comprises: determining a velocity of the vehicle; and determining a velocity limit of a driving lane associated with the vehicle, wherein the cost is determined based at least in part on a combination of the overlap portion of the vehicle in the first region, the velocity of the vehicle, and the velocity limit.

I: The one or more non-transitory computer-readable media of paragraph H, wherein the object is a first object, wherein determining the cost is further based at least in part on a velocity of a second object that is different than the first object.

J: The one or more non-transitory computer-readable media of paragraph F, wherein the object is a double-parked object, wherein the double-parked object is in a laterally adjacent driving lane that is associated with an opposite direction of travel from a direction of travel associated with the vehicle.

K: The one or more non-transitory computer-readable media of paragraph J, wherein determining that the object is the double-parked object comprises: determining a distance from a side of the object to a lane marker; and determining that the distance is less than a threshold distance.

L: The one or more non-transitory computer-readable media of paragraph K, wherein the object is a first object, wherein the threshold distance is determined based at least in part on a classification of a second object that is different than the first object.

M: The one or more non-transitory computer-readable media of paragraph F, wherein determining the cost comprises: determining a velocity of the object; and determining a velocity limit of a driving lane associated with the object, wherein the cost is determined based at least in part on a combination of the velocity of the object, and the velocity limit.

N: A method comprising: receiving sensor data representative of an environment; detecting, based at least in part on the sensor data, an object; determining a heatmap associated with a first region of the environment that encompasses the object; determining a candidate action for a vehicle to follow; determining, based at least in part on the candidate action, a future state of the vehicle; determining, based at least in part on the future state of the vehicle, an overlap portion between a second region occupied by the vehicle at the future state and the first region of the heatmap; and determining, based at least in part on the heatmap and the overlap portion, a cost of following the candidate action.

O: The method of paragraph N, wherein determining the cost comprises: determining a weight associated with the heatmap, wherein the cost is determined based at least in part on a combination of the weight and the overlap portion of the vehicle in the first region.

P: The method of paragraph N, wherein determining the cost comprises: determining a velocity of the vehicle; and determining a velocity limit of a driving lane associated with the vehicle, wherein the cost is determined based at least in part on a combination of the overlap portion of the vehicle in the first region, the velocity of the vehicle, and the velocity limit.

Q: The method of paragraph P, wherein the object is a first object, wherein determining the cost is further based at least in part on a velocity of a second object that is different than the first object.

R: The method of paragraph N, wherein the object is a double-parked object, wherein the double-parked object is in a laterally adjacent driving lane that is associated with an opposite direction of travel from a direction of travel associated with the vehicle.

S: The method of paragraph R, wherein determining that the object is the double-parked object comprises: determining a distance from a side of the object to a lane marker; and determining that the distance is less than a threshold distance.

T: The method of paragraph S, wherein the object is a first object, wherein the threshold distance is determined based at least in part on a classification of a second object that is different than the first object.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing computer-executable instructions that, when executed, cause the system to perform operations comprising:
receiving, from a sensor device associated with an autonomous vehicle, sensor data representative of an environment;
detecting, based at least in part on the sensor data, an object;
determining that the object is a stationary vehicle in a laterally adjacent driving lane;
determining, based at least in part on the object being the stationary vehicle, a heatmap associated with a first region of the environment that encompasses the object;
determining a candidate action for the autonomous vehicle to follow;
determining, based at least in part on the candidate action, a future state of the autonomous vehicle;
determining, based at least in part on the future state of the autonomous vehicle, an overlap portion between a second region occupied by the autonomous vehicle at the future state and the first region of the heatmap;
determining, based at least in part on the heatmap and the overlap portion, a cost of following the candidate action; and
controlling the autonomous vehicle based at least in part on the cost.

2. The system of claim 1, wherein determining that the object is the stationary vehicle comprises:
determining a distance from a side of the object to a lane marker; and
determining that the distance is less than a threshold distance.

3. The system of claim 2, wherein the object is a first object, wherein the threshold distance is determined based at least in part on a classification of a second object that is different than the first object.

4. The system of claim 1, wherein determining the cost comprises:
determining a weight associated with the heatmap, wherein the cost is determined based at least in part on a combination of the weight and the overlap portion of the autonomous vehicle in the first region.

5. The system of claim 1, wherein determining the cost comprises:
determining a velocity of the autonomous vehicle; and
determining a velocity limit of a driving lane associated with the autonomous vehicle, wherein the cost is determined based at least in part on a combination of the overlap portion of the autonomous vehicle in the first region, the velocity of the autonomous vehicle, and the velocity limit.

6. One or more non-transitory computer-readable media storing instructions executable by one or more processors, wherein the instructions, when executed, cause a system to perform operations comprising:
receiving sensor data representative of an environment;
detecting, based at least in part on the sensor data, an object;
determining a heatmap associated with a first region of the environment that encompasses the object;
determining a candidate action for a vehicle to follow;
determining, based at least in part on the candidate action, a future state of the vehicle;
determining, based at least in part on the future state of the vehicle, an overlap portion between a second region occupied by the vehicle at the future state and the first region of the heatmap; and
determining, based at least in part on the heatmap and the overlap portion, a cost of following the candidate action.

7. The one or more non-transitory computer-readable media of claim 6, wherein determining the cost comprises:
determining a weight associated with the heatmap, wherein the cost is determined based at least in part on a combination of the weight and the overlap portion of the vehicle in the first region.

8. The one or more non-transitory computer-readable media of claim 6, wherein determining the cost comprises:
determining a velocity of the vehicle; and
determining a velocity limit of a driving lane associated with the vehicle, wherein the cost is determined based at least in part on a combination of the overlap portion of the vehicle in the first region, the velocity of the vehicle, and the velocity limit.

9. The one or more non-transitory computer-readable media of claim 8, wherein the object is a first object, wherein determining the cost is further based at least in part on a velocity of a second object that is different than the first object.

10. The one or more non-transitory computer-readable media of claim 6, wherein the object is a double-parked object, wherein the double-parked object is in a laterally adjacent driving lane that is associated with an opposite direction of travel from a direction of travel associated with the vehicle.

11. The one or more non-transitory computer-readable media of claim 10, wherein determining that the object is the double-parked object comprises:
determining a distance from a side of the object to a lane marker; and
determining that the distance is less than a threshold distance.

12. The one or more non-transitory computer-readable media of claim 11, wherein the object is a first object, wherein the threshold distance is determined based at least in part on a classification of a second object that is different than the first object.

13. The one or more non-transitory computer-readable media of claim 6, wherein determining the cost comprises:
determining a velocity of the object; and
determining a velocity limit of a driving lane associated with the object, wherein the cost is determined based at least in part on a combination of the velocity of the object, and the velocity limit.

14. A method comprising:
receiving sensor data representative of an environment;
detecting, based at least in part on the sensor data, an object;
determining a heatmap associated with a first region of the environment that encompasses the object;
determining a candidate action for a vehicle to follow;
determining, based at least in part on the candidate action, a future state of the vehicle;
determining, based at least in part on the future state of the vehicle, an overlap portion between a second region occupied by the vehicle at the future state and the first region of the heatmap; and
determining, based at least in part on the heatmap and the overlap portion, a cost of following the candidate action.

15. The method of claim 14, wherein determining the cost comprises:
determining a weight associated with the heatmap, wherein the cost is determined based at least in part on a combination of the weight and the overlap portion of the vehicle in the first region.

16. The method of claim 14, wherein determining the cost comprises:
determining a velocity of the vehicle; and
determining a velocity limit of a driving lane associated with the vehicle, wherein the cost is determined based at least in part on a combination of the overlap portion of the vehicle in the first region, the velocity of the vehicle, and the velocity limit.

17. The method of claim 16, wherein the object is a first object, wherein determining the cost is further based at least in part on a velocity of a second object that is different than the first object.

18. The method of claim 14, wherein the object is a double-parked object, wherein the double-parked object is in a laterally adjacent driving lane that is associated with an opposite direction of travel from a direction of travel associated with the vehicle.

19. The method of claim 18, wherein determining that the object is the double-parked object comprises:
determining a distance from a side of the object to a lane marker; and
determining that the distance is less than a threshold distance.

20. The method of claim 19, wherein the object is a first object, wherein the threshold distance is determined based at least in part on a classification of a second object that is different than the first object.
